(19) United States
(12) Patent Application Publication
(10) Pub. No.: US 2015/0009790 A1
(43) Pub. Date: Jan. 8, 2015

(54) OBJECTIVE LENS AND OPTICAL PICKUP DEVICE

(71) Applicants: SANYO ELECTRIC CO., LTD., Moriguschi-shi, Osaka (JP); Sanyo Optec Design Co., Ltd., Ora-gun, Gunma (JP)

(72) Inventors: Mitsuru Ito, Kanagawa (JP); Yuki Koshimizu, Kumamoto (JP); Yoshitoshi Oyamada, Gunma (JP); Hiroyuki Ichikawa, Saitama (JP)

(21) Appl. No.: 14/376,368

(22) PCT Filed: Dec. 18, 2012
(86) PCT No.: PCT/JP2012/082717

§ 371 Date: Aug. 1, 2014

(30) Foreign Application Priority Data
Feb. 9, 2012 (JP) 2012-026234

(51) Int. Cl. G11B 7/1374; G02B 13/18

(52) U.S. Cl. CPC G11B 7/1374; G02B 13/18
USPC 369/112.26; 359/719

(57) ABSTRACT

[PROBLEM]

To provide an object lens such that the degradation of the optical properties of the object lens due to temperature change can be minimized, and a light pickup device using the same.

[SOLUTION]

An object lens R has lens surfaces R1, R2 which converges BD light, DVD light and CD light with prescribed numerical apertures into spots, and an antireflective film R1a formed on the lens surface R1. The lens surface R1 includes a BD exclusive region A1, a two-wavelength common region A2, and a three-wavelength common region A3. Diffractive structures P1, P2 and P3 are formed respectively for the BD exclusive region A1, the two-wavelength common region A2 and the three-wavelength common region A3. The antireflective film R1a is designed such that the transmittance for BD light is largest in the range of the two-wavelength common region A2.

### TECHNICAL FIELD

The present invention relates to an objective lens, and an optical pickup device provided with the objective lens.

### RELATED ART

There is known an optical pickup device configured such that laser light in wavelength bands different from each other is converged on a corresponding optical disc by one objective lens. In this configuration, the objective lens is required to converge the respective laser light with numerical apertures different from each other among the laser light. In view of the above, the lens surface of the objective lens is radially divided into a plurality of areas, and diffraction structures different from each other are formed in the areas.

For instance, in the case where an objective lens is compatible with a Blu-ray disc (hereinafter, referred to as “BD”), a digital versatile disc (hereinafter, referred to as “DVD”) , and a compact disc (hereinafter, referred to as “CD”), a 3-wavelength compatible diffraction structure for BD, DVD, and CD, a 2-wavelength compatible diffraction structure for BD and DVD, and a diffraction structure for BD are formed on the lens surface (for example, Patent Document 1).

### PRIOR ART DOCUMENT

### Patent Document

Patent Document 1: Unexamined Patent Publication No. 2011-187119

### DISCLOSURE OF THE INVENTION

### Problem to be Solved by the Invention

In the objective lens having the above configuration, when the temperature is changed from an ambient temperature (e.g. 25° C.) to a high temperature (e.g. 65° C.), the refractive index or the shape of the objective lens may change, and the numerical aperture and the aberration may vary in accordance with the change. If the numerical aperture or the aberration varies, laser light may not be properly converged on a corresponding disc, and the optical characteristics of the objective lens may be deteriorated.

The invention has been made to solve such problem, and its object is to provide an objective lens capable of minimizing the degradation of optical properties of the objective lens and an optical pickup device using the same.

### Means for Solving the Problem

A first aspect of the invention relates to an objective lens configured to receive first laser light in a first wavelength band, second laser light in a second wavelength band on a longer wavelength side than the first wavelength band, and third laser light in a third wavelength band on a longer wavelength side than the second wavelength band. The objective lens according to the first aspect is provided with a lens portion configured to converge the first laser light, the second laser light, and the third laser light respectively into a light spot with a first numerical aperture, a second numerical aperture smaller than the first numerical aperture, and a third numerical aperture smaller than the second numerical aperture, and an anti-reflection film formed on an incident surface of the lens portion. The lens portion includes, on the incident surface, a first area obtained by excluding an area corresponding to an effective diameter of the second laser light from an area corresponding to an effective diameter of the first laser light, a second area obtained by excluding an area corresponding to an effective diameter of the third laser light from the area corresponding to the effective diameter of the second laser light, and a third area corresponding to the effective diameter of the third laser light, wherein diffraction structures different from each other are respectively formed in the second area and in the third area. The anti-reflection film is designed such that a transmittance with respect to the first laser light is maximum within the second area.

According to the first aspect of the present invention, since the transmittance with respective to the first laser light becomes better in an area that is subjected to an aberration variation due to a temperature change, it can be possible to minimize the degradation of optical properties of the objective lens.

In one aspect, it is desirable that a position of the anti-reflection film at which the transmittance with respect to the first laser light is maximum is close to a radially outer side of the second area than a center of the second area. Accordingly, since the transmittance with respect to the first laser light becomes better at the position of the outer periphery where the interface reflectance becomes greater in the second area, it can further be possible to minimize the degradation of optical properties of the objective lens.

In one embodiment, a diffraction structure different from the diffraction structures formed in the second area and in the third area may further be formed in the first area of the lens portion.

In this aspect, the anti-reflection film may be designed such that the transmittance with respect to the first laser light decreases, as an incident position of the first laser light is away from an optical axis on the incident surface within the first area. Accordingly, since the anti-reflection film is designed so that the transmittance does not become greater in the periphery of the lens portion, it may be possible to converge the first laser light into a spot having a proper diameter.

Further, the first laser light may be laser light for a Blu-ray disc, the second laser light may be laser light for a digital versatile disc, and the third laser light may be laser light for a compact disc.

A second aspect of the invention relates to an optical pickup device. The optical pickup device according to the second aspect includes a light source configured to output laser light in a plurality of wavelength bands; and the objective lens according to the first aspect configured to receive the laser light.

According the second aspect of the optical pickup device, similar to the above first aspect, since the transmittance becomes better in an area that is subjected to an aberration variation due to a temperature change, it can be possible to minimize the degradation of optical properties of the optical pickup device.

### Effect of the Invention

Based on the above, according to the present invention, it can be possible to provide an objective lens and an optical pickup device using the same for minimizing the degradation of optical properties of an objective lens.

Features of the present invention will be revealed by the following description of embodiments. However, the following embodiments are examples of the present invention, and the meanings of the terms for the present invention and each element are not limited to the following description of embodiments.

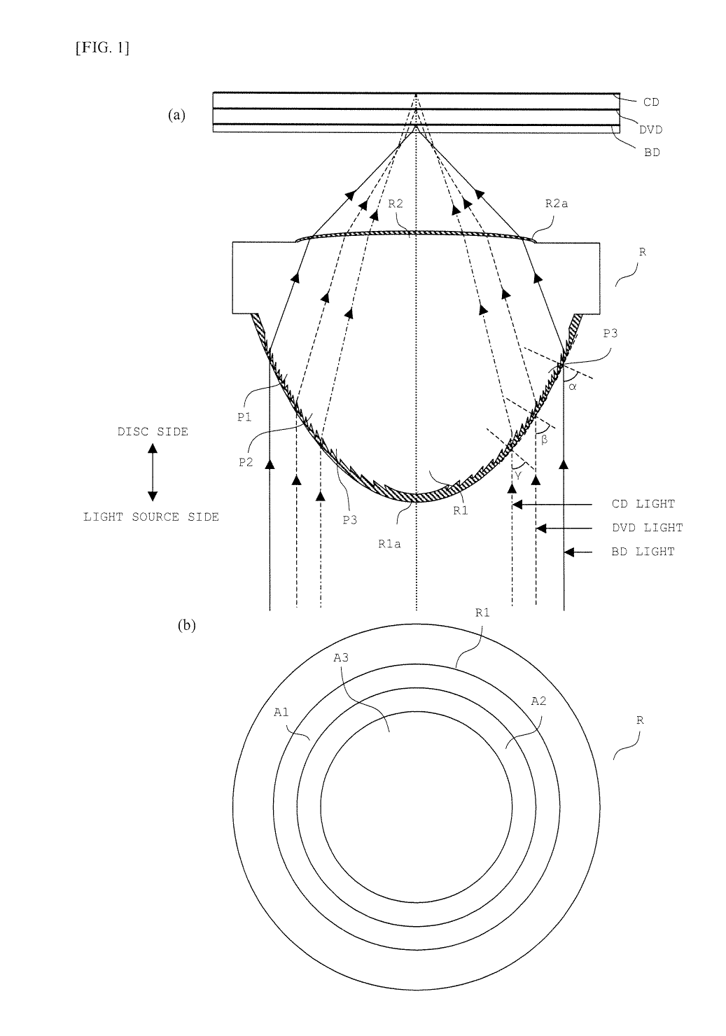

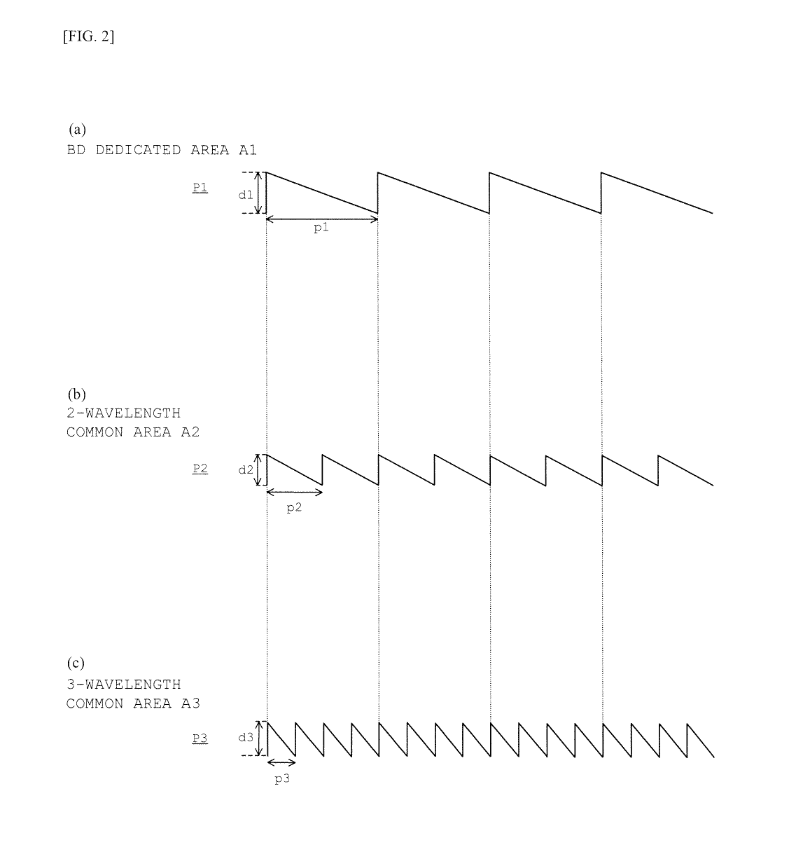

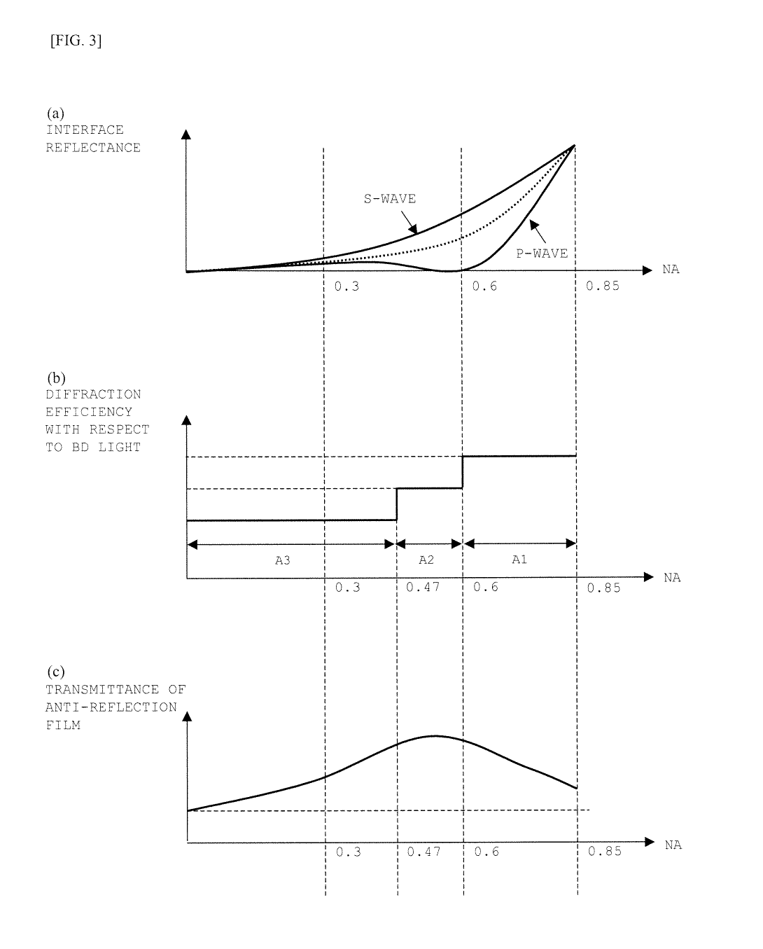

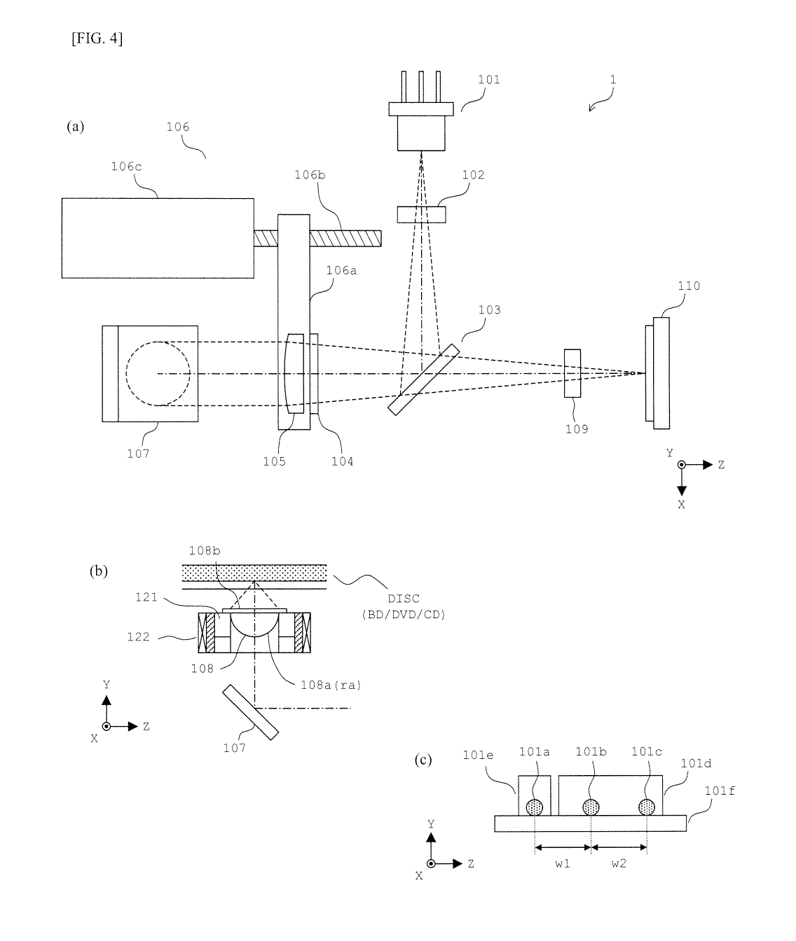

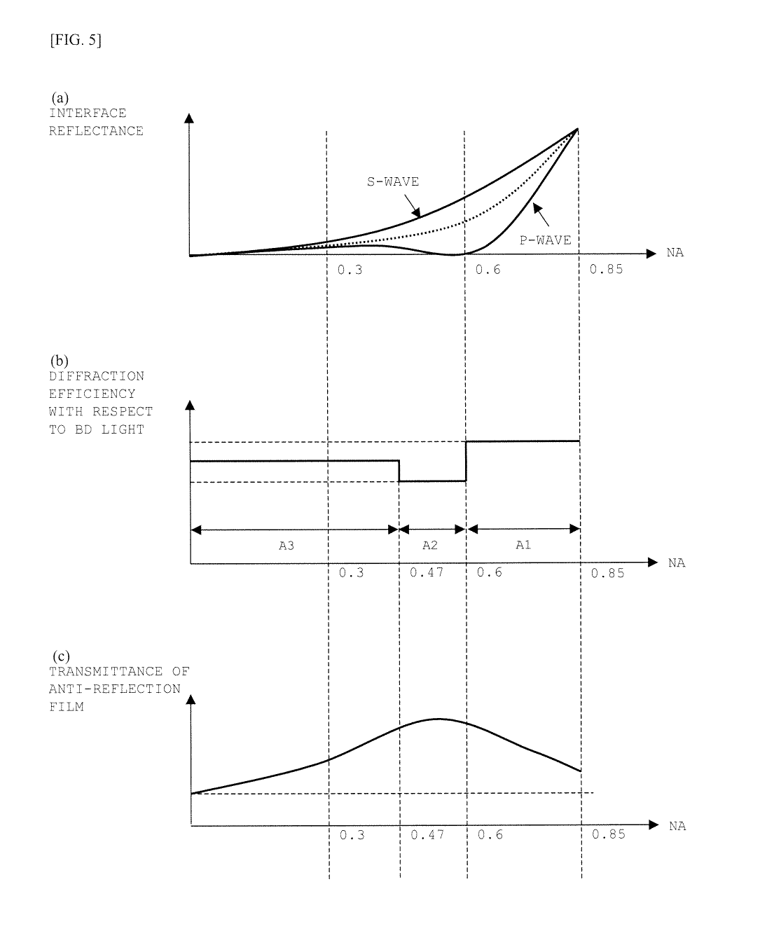

### BRIEF DESCRIPTION OF THE DRAWINGS

[FIG. 1] Figure show an objective lens according to one embodiment.

[FIG. 2] A figure shows an exemplary diffraction structure according to one embodiment.

[FIG. 3] Graphs show characteristics of a numerical aperture, reflectance, and transmissivity of an objective lens according to one embodiment.

[FIG. 4] Figure show an optical pickup device according to one embodiment.

[FIG. 5] Graphs show characteristics of a numerical aperture, reflectance, and transmissivity of an objective lens according to one modification.

### DESCRIPTION OF EMBODIMENTS OF THE INVENTION

In the following, embodiments of the present invention will be described with reference to the drawings. In one embodiment, the present invention is applied to an objective lens and an optical pickup device compatible with BD/DVD/CD.

### Objective Lens

FIG. 1(a) is a schematic cross-sectional view of an objective lens R taken along a plane including the optical axis of the objective lens R and in parallel to the optical axis, and FIG. 1(b) is a plan view of the objective lens R as viewed from the light source side. Referring to FIG. 1(a), out of rays of laser light (hereinafter, referred to as “BD light”) for BD, laser light (hereinafter, referred to as “DVD light”) for DVD, and laser light (hereinafter, referred to as “CD light”) for CD, the light rays passing through an outermost periphery in the effective diameter area necessary for each laser light are illustrated.

The objective lens R has a perfect circular shape in plan view. The objective lens R is made of a resin material having excellent optical transparency. A lens surface R1 is formed on the light source side of the objective lens R, and a lens surface R2 is formed on the disc side of the objective lens R.

The lens surface R1 is a convex surface of an aspherical shape projecting toward the light source side. The diameter of the lens surface R1 is set to be larger than the diameter of the lens surface R2, and the curvature of the lens surface R1 is set to be larger than the curvature of the lens surface R2.

Each of the lens surfaces R1 and R2 is configured to converge BD light, DVD light, and CD light entered as parallel light on a signal recording surface of BD, DVD, and CD. BD light, DVD light, and CD light entered to the lens surface R1 are refracted on the lens surface R1 in a direction toward the optical axis, and is directed toward the lens surface R2. BD light, DVD light, and CD light refracted on the lens surface R1 are refracted on the lens surface R2 in a direction toward the optical axis. BD light converged by the objective lens R as described above is entered to BD with a large numerical aperture (NA=0.85) suitable for BD. Further, DVD light is entered to DVD with a numerical aperture (NA=0.6) smaller than the numerical aperture with respect to BD light, and CD light is entered to CD with a numerical aperture (NA=0.47) smaller than the numerical aperture with respect to DVD light. Thereafter, BD light, DVD light, and CD light are respectively refracted on a cover layer of BD, DVD, and CD, and are focused on the signal recording surface.

Anti-reflection films R1a and R2a are respectively formed on the outer surfaces of the lens surfaces R1 and R2. The anti-reflection films R1a, R2a are multilayer films formed by laminating thin films having refractive indexes different from each other. The film thickness and the number of layers of the anti-reflection film R1a, R2a are designed to suppress reflection of light necessary on the lens surface, and to enhance the transmittance with respect to necessary light.

Further, concentric circular-shaped diffraction structures are formed on the lens surface R1 in order to converge BD light, DVD light, and CD light on BD, DVD, and CD, respectively. Each of the diffraction structures is an annular belt-shaped blazed diffraction structure having a predetermined pitch and a predetermined height. The diffraction structures are configured to change the convergent states of BD light, DVD light, and CD light by a diffraction effect.

A diffraction structure P3 is formed in an area A3 (hereinafter, referred to as “3-wavelength common area”) corresponding to the effective diameter of CD light on the lens surface R1 to properly converge BD light, DVD light, and CD light . Further, a diffraction structure P2 is formed in an area A2 (hereinafter, referred to as “2-wavelength common area”) corresponding to the effective diameter of DVD light except for the area A3 to properly converge BD light and DVD light . Further, a diffraction structure P1 is formed in an area A1 (hereinafter, referred to as “BD dedicated area”) corresponding to the effective diameter of BD light on the lens surface R1 except for the area A3 and the area A2 to properly converge BD light.

The diffraction structure P3 to be formed in the 3-wavelength common area A3 has a finely designed pattern in order to implement a diffraction effect of converging three laser light i.e. BD light, DVD light, and CD light at a predetermined position. On the other hand, the diffraction structure P3 to be formed in the 2-wavelength common area A2 has a pattern simpler than the pattern of the diffraction structure P3 to be formed in the 3-wavelength common area A3, because a diffraction effect of converging two laser light i.e. BD light and DVD light is required to be converged at a predetermined position, and the diffraction structure P1 to be formed in the BD dedicated area A1 has a much simpler pattern because only BD light is required to be converged at a predetermined position. The anti-reflection film R1a is formed over the entirety of the lens surface R1 in such a manner as to cover the upper surfaces of the diffraction structures P1 to P3.

FIG. 1(a) illustrates rays of BD light passing through the outermost periphery of the BD dedicated area A1, rays of DVD light passing through the outermost periphery of the 2-wavelength common area A2, and rays of CD light passing through the outermost periphery of the 3-wavelength common area A3. Light to be entered to the lens surface R1 is such that the incident angle (tangent angle) increases toward the periphery of the lens surface R1. FIG. 1(a) illustrates the maximum incident angles (maximum tangent angles) of BD light, DVD light, and CD light as α, β, and γ.

FIGS. 2(a) to 2(c) are diagrams respectively illustrating pattern examples of the diffraction structures P1 to P3. These figures schematically illustrate blaze shapes of the diffraction structures P1 to P3 when the objective lens R is taken along a plane including the optical axis of the objective lens R and in parallel to the optical axis.

As described above, the diffraction structure P1 is configured such that the pitch p1 and the height d1 of a blaze grating are adjusted to converge diffracted light of a predetermined order of BD light at the focus position Pb. Further, as described above, the diffraction structure P2 is configured such that the pitch p2 and the height d2 of a blaze grating are adjusted to converge diffracted light of a predetermined order of BD light and diffracted light of a predetermined order of DVD light respectively at the focus positions Pb and Pd. Furthermore, as described above, the diffraction structure P3 is configured such that the pitch p3 and the height d3 of a blaze grating are adjusted to converge diffracted light of a predetermined order of BD light, diffracted light of a predetermined order of DVD light, and diffracted light of a predetermined order of CD light respectively at the focus positions Pb, Pd, and Pc.

In the above design, the diffraction structures P2 and P1 are designed such that CD light entered to the 2-wavelength common area A2 and to the BD dedicated area A1 is diffracted in a direction different from the direction toward the focus position Pc by the diffraction structures P2 and P1. Further, the diffraction structure P1 is designed such that DVD light entered to the BD dedicated area A1 is diffracted in a direction different from the direction toward the focus position Pd by the diffraction structure P1.

A blaze grating to be formed in each of the areas for diffraction may be formed in a non-periodic step or in a periodic step which forms a phase other than the phase of the blaze grating.

FIG. 3(a) is a graph schematically illustrating a relationship between an interface reflectance and a numerical aperture. FIG. 3(a) illustrates the interface reflectances of p-wave and s-wave by solid lines, and a substantial interface reflectance obtained by summing up the interface reflectances of p-wave and s-wave by the broken line. Further, the vertical axis in FIG. 3(a) denotes the interface reflectance in the lens surface R1, and the horizontal axis in FIG. 3(a) denotes the numerical aperture of the lens surface R1. As the numerical aperture increases, the tangent angle of light to be entered to the lens surface R1 increases.

Referring to FIG. 3(a), the interface reflectance of p-wave increases with a slight gradient up to a position near the numerical aperture of 0.3, and thereafter, turns into a Brewster's angle of substantially zero in the vicinity of the numerical aperture of 0.6. Then, when the interface reflectance of p-wave exceeds the Brewster's angle, the interface reflectance sharply increases. On the other hand, the interface reflectance of s-wave monotonously increases in the numerical aperture range from 0 to 0.85.

As described above, the interface reflectance obtained by summing up the interface reflectances of p-wave and s-wave increases, as the numerical aperture increases. In particular, when the numerical aperture exceeds 0.6 corresponding to a Brewster's angle, the interface reflectance sharply increases. As a result, the reflectance with respect to CD light in a lens surface having a small numerical aperture is small, and the reflectances with respect to BD light and DVD light in a lens surface having a large numerical aperture are large. In other words, the interface reflectance increases toward the periphery of the lens surface R1, and the light amount loss of the laser light is likely to increase.

FIG. 3(b) is a graph schematically illustrating a relationship between a diffraction efficiency with respect to BD light, and a numerical aperture. FIG. 3(b) illustrates examples of diffraction efficiency with respect to each of the numerical apertures.

Referring to FIG. 3(b), as illustrated in FIG. 2(c), the area having a numerical aperture of smaller than 0.47 corresponds to the 3-wavelength common area A3, in which the diffraction structure for BD light, DVD light, and CD light is formed. A diffraction pattern having a finest pattern is formed in this area to be compatible with laser light in three wavelength bands. In the embodiment, the diffraction efficiency with respect to BD light in this area is set to be lowest.

Further, as illustrated in FIG. 2(b), the area having a numerical aperture of not smaller than 0.47 but smaller than 0.6 corresponds to the 2-wavelength common area A2, in which the diffraction structure for BD light and DVD light is formed. A diffraction pattern having a moderately fine pattern is formed in this area to be compatible with laser light in two wavelength bands. In the embodiment, the diffraction efficiency with respect to BD light in this area is set to be higher than the diffraction efficiency in the 3-wavelength common area A3 but is set to be lower than the diffraction efficiency in the BD dedicated area A1.

Furthermore, as illustrated in FIG. 2(a), the area having a numerical aperture of not smaller than 0.6 but smaller than 0.85 corresponds to the BD dedicated area A1 compatible with only BD light. A diffraction pattern compatible with only laser light in one wavelength band is formed in this area. Accordingly, the diffraction efficiency with respect to BD light in this area is set to be highest.

As described above, in the embodiment, the diffraction efficiency with respect to BD light is set to be small in the area having a small numerical aperture, and is set to be large in the area having a large numerical aperture. In other words, contrary to FIG. 3(a), the transmittance with respect to BD light increases, as the area has a larger numerical aperture.

The intensity of BD light to be entered to the lens surface R1 has a so-called Gaussian distribution such that the intensity is highest in the center (optical axis position) of the lens surface and gradually decreases toward the periphery of the lens surface. On the other hand, it is necessary to set the intensity difference between the center and the periphery of BD light in order to decrease the spot diameter of BD light. In view of the above, as illustrated in FIG. 3(b), as the diffraction efficiency in the periphery (area having a large numerical aperture) of the lens surface increases, it is possible to make the intensity of BD light in the periphery close to the intensity of BD light in the center, and thus it is possible to converge BD light into a light spot having a small diameter.

As described above, it is desirable to make the intensity of the periphery of BD light close to the intensity of the center of BD light in order to converge BD light into a light spot having a small diameter. In this aspect, it is desirable to design the anti-reflection film R1a such that the maximum value of the transmittance with respect to BD light comes close to the transmittance in the periphery of the lens surface R1.

However, in the embodiment, as illustrated in FIG. 3(c), the maximum value of the transmittance of the anti-reflection film R1a with respect to BD light is set in the 2-wavelength common area A2 having a numerical aperture of not smaller than 0.47 but smaller than 0.6, not in the periphery of the lens surface R1. In FIG. 3(c), the horizontal axis denotes a numerical aperture, and the vertical axis denotes a transmittance of the anti-reflection film R1a. It is impossible to make the transmittance of the anti-reflection film R1a uniform over the entirety of the lens surface due to the property of film formation, and typically, the anti-reflection film R1a is designed to have a peak at a position corresponding to one of the numerical apertures.

In the embodiment, the maximum value of the transmittance of the anti-reflection film R1a is set in the 2-wavelength common area A2 for the following reason.

As described above, the refractive index or the shape of the objective lens R made of resin is likely to change due to a temperature change, as compared with a lens made of glass. If the refractive index or the shape of a diffraction structure is deviated from a design value due to a temperature change, the diffraction effect of the diffraction structure may fluctuate, and the numerical aperture or the aberration may vary. As a result, it is difficult to collect laser light at one point, and a defocus state may occur. Consequently, the light amount of a light spot to be converged on a disc may be lowered, and recording/reproducing characteristics may be deteriorated.

Generally, the aforementioned phenomenon becomes conspicuous, as the incident angle (tangent angle) of BD light increases. Accordingly, a numerical aperture variation or an aberration variation due to a temperature change is small in the inner periphery (3-wavelength common area A3) of the lens surface R1, in which the incident angle (tangent angle) is small, and increases toward the outer periphery (BD dedicated area A1)

Further, the aforementioned phenomenon becomes conspicuous, as the diffraction structure is finely formed. If a diffraction structure is formed to be compatible with laser light in wavelength bands different from each other, the diffraction structure may have a fine pattern, and a change in the refractive index and the shape are likely to affect a diffraction effect. Further, strict diffraction conditions are required for laser light of each wavelength in order to form a diffraction structure compatible with laser light in wavelength bands different from each other. As a result, as the number of corresponding wavelength bands increases, it is difficult to allow displacement of the diffraction structure with respect to a design value. Consequently, as the number of corresponding wavelength bands increases and the pattern of the diffraction structure becomes fine, the diffraction structure is likely to be affected by the diffraction effect due to a temperature change.

The 3-wavelength common area A3 having a numerical aperture of smaller than 0.47 is formed with a diffraction structure having a finest pattern to be compatible with laser light in three wavelength bands, and accordingly, the 3-wavelength common area A3 may be most affected by the diffraction effect due to a temperature change. However, BD light to be entered to this area has a sufficiently small incident angle (tangent angle) with respect to the lens surface R1, and accordingly, a variation in the diffraction effect due to a temperature change is significantly small. Further, since this area to which BD light is entered has a small numerical aperture, the focal depth is large, and BD light is less likely to be defocused. Accordingly, BD light is easily converged at an intended focus position in this area, even if the temperature of the objective lens R changes.

BD light to be entered to the BD dedicated area A1 having a numerical aperture of not smaller than 0.6 has a large incident angle (tangent angle) with respect to the lens surface R1, and accordingly, an influence such as an aberration variation due to a temperature change is large, in view of a relationship with the incident angle (tangent angle). Further, since BD light to be entered to this area has a large numerical aperture, the focal depth is small, and BD light is likely to be defocused due to a numerical aperture variation or an aberration variation. However, it is possible to design the area exclusively for BD light, accordingly, it is possible to design the diffraction structure to have a simple pattern in order to suppress an influence due to a shape change or a refractive index variation in advance. Thus, it is relatively easy to suppress an influence due to a temperature change in this area by design.

On the other hand, the 2-wavelength common area A2 having a numerical aperture of not smaller than 0.47 but smaller than 0.6 is formed to have a diffraction structure of a relatively fine pattern to be compatible with two wavelengths, BD light to be entered to this area has a large incident angle with respect to the lens surface R1, and as a result, fluctuations in the diffraction effect due to a temperature change are likely to increase. Further, since this area to which BD light is entered has a large numerical aperture, the focal depth is small, and BD light is likely to be defocused due to a numerical aperture variation or an aberration variation. Furthermore, it is necessary to form a diffraction structure in this area, taking into consideration of DVD light, in addition to BD light, and therefore, it is difficult to suppress an influence due to a temperature change by design. Thus, out of the three areas A1 to A3, BD light is most likely to be defocused in the 2-wavelength common area A2 due to a temperature change, and as a result, the intensity of BD light at the focus position is likely to be insufficient.

In view of the above, in the embodiment, as illustrated in FIG. 3(c), the anti-reflection film R1a is designed to obtain a satisfactory transmittance with respect to BD light in the 2-wavelength common area A2 having a numerical aperture of not smaller than 0.47 but smaller than 0.6.

Referring to FIG. 3(c), when the numerical aperture is 0, the transmittance with respect to BD light is lowest in the anti-reflection film R1a. Thereafter, the transmittance with respect to BD light monotonously increases in the anti-reflection film R1a until the numerical aperture is equal to 0.5. When the numerical aperture is substantially equal to 0.5, the transmittance with respect to BD light is maximum in the anti-reflection film R1a. Thereafter, the transmittance with respect to BD light monotonously decreases in the anti-reflection film R1a until the numerical aperture is equal to 0.85.

As described above, the anti-reflection film R1a in the embodiment is designed such that the transmittance with respect to BD light is maximum in the 2-wavelength common area A2 having a numerical aperture of not smaller than 0.47 but smaller than 0.6. According to this configuration, it is possible to compensate for the light amount in the 2-wavelength common area A2, in which the light amount is likely to be insufficient due to a temperature change of the objective lens R, and accordingly, it is possible to properly maintain the light amount of a spot of BD light to be converged on a disc, and to suppress deterioration of recording/reproducing characteristics.

In the design example illustrated in FIG. 3(c), the anti-reflection film R1a is designed such that the transmittance with respect to BD light is maximum at a position where the numerical aperture is substantially equal to 0.5. However, as illustrated in FIG. 3(a), the interface reflectance in the 2-wavelength common area A2 increases toward the outer periphery of a lens surface, and as a result, an influence such as an aberration variation due to a temperature change also increases toward the outer periphery of a lens surface. In view of the above, it is desirable to set the position on the anti-reflection film R1a, at which the transmittance with respect to BD light is maximum, on the outer peripheral side of the 2-wavelength common area A2 than the center thereof, and more preferably, it is desirable to set the position near the outermost periphery of the 2-wavelength common area A2.

Further, if the light amount in the periphery of the lens surface R1 excessively increases, as compared with the light amount in the center of the lens surface R1, the spot diameter may unduly decrease due to a super resolution phenomenon. In view of the above, as illustrated in FIG. 3(c), it is desirable to design the anti-reflection film R1a such that the transmittance with respect to BD light is gradually lowered in the BD dedicated area A1 having a numerical aperture of not smaller than 0.6 but smaller than 0.85.

### Optical Pickup Device

In the following, a configuration example of an optical pickup device incorporated with the objective lens R having the above configuration is described.

FIG. 4 illustrates a configuration of an optical system of an optical pickup device. FIG. 4(a) is a top plan view of the optical system except for an objective lens actuator, FIG. 4(b) is an internal perspective view of the objective lens actuator and peripheral parts thereof, as viewed from a side of the optical pickup device, FIG. 4(c) is a diagram illustrating a disposition state of laser elements 101a to 101c in a semiconductor laser 101.

Referring to FIG. 4(a), the optical pickup device is provided with the semiconductor laser 101, a diffraction grating 102, a flat plate-shaped polarized beam splitter (PBS) 103, a λ/4 plate 104, a collimator lens 105, a lens actuator 106, a rise-up mirror 107, an objective lens 108, a diffraction optical element 109, and a photodetector 110.

The semiconductor laser 101 is configured to output laser light (BD light) for BD of about 405-nm wavelength, laser light (DVD light) for DVD of about 660-nm wavelength, and laser light (CD light) for CD of about 785-nm wavelength.

As illustrated in FIG. 4(c), the semiconductor laser 101 is provided with the laser elements 101a, 101b, and 101c respectively configured to output BD light, DVD light, and CD light in one CAN. The laser elements 101b and 101c are integrally formed on a substrate 101d in such a manner that the interval between the light emission points is set to w2, and the laser element 101a is formed on another substrate 101e in such a manner that the interval between the light emission point of the laser element 101a and the light emission point of the laser element 101b is set to w1 (w1>w2). The laser elements 101a, 101b, and 101c are disposed such that the light emission points thereof are linearly aligned by mounting the substrates 101d and 101e on a sub-mount 101f in the CAN. The optical system posterior to the semiconductor laser 101 is adjusted so that the optical axis of the optical system is aligned with the optical axis of DVD light.

The diffraction grating 102 is configured to divide only BD light, out of BD light, DVD light, and CD light output from the semiconductor laser 101, into a main beam and two sub beams. DVD light and CD light are also subjected to the diffraction effect of the diffraction grating 102, but the intensities of sub beams of DVD light and CD light are extremely small.

The PBS 103 is configured to reflect laser light entered from the diffraction grating 102 side. The PBS 103 is in the form of a thin parallel flat plate, and a polarization film is formed on the incident surface of the PBS 103. The semiconductor laser 101 is disposed at such a position that the polarization directions of BD light, DVD light, and CD light are aligned with the direction of S-polarized light with respect to the PBS 103.

The λ/4 plate 104 is configured to convert laser light reflected on the PBS 103 into circularly polarized light, and to convert reflected light on a disc into linearly polarized light in a direction orthogonal to the polarization direction of light toward the disc. According to this configuration, laser light reflected on the disc is guided to the photodetector 110 through the PBS 103.

The collimator lens 105 is configured to convert laser light reflected on the PBS 103 into parallel light. The lens actuator 106 is configured to drive the λ/4 plate 104 and the collimator lens 105 in the optical axis direction of the collimator lens 105.

The lens actuator 106 is provided with a moving member 106a, a gear 106b, and a motor 106c. The moving member 106a is configured to hold the λ/4 plate 104 and the collimator lens 105. The moving member 106a is supported by a guide (not illustrated) to be movable in the optical axis direction of the collimator lens 105. Further, a gear (not illustrated) is provided on the moving member 106, and the gear meshes with the gear 106b. The gear 106b is connected to a driving shaft of a motor 106c. Driving the motor 106c causes the collimator lens 105 held on the moving member 106a to move together with the λ/4 plate 104. In this way, moving the collimator lens 105 in accordance with a control signal makes it possible to correct aberration (spherical aberration) generated in laser light.

The rise-up mirror 107 is configured to reflect laser light entered through the collimator lens 105 in a direction toward the objective lens 108.

The objective lens 108 is designed to converge BD light, DVD light, and CD light on a signal surface of a corresponding disc. The objective lens 108 includes a lens surface 108a formed with an anti-reflection film ra on the light source side thereof, and a lens surface 108b on the disc side thereof, as well as the objective lens R according to the embodiment. The lens surface 108b is radially divided into three areas i.e. a BD dedicated area A1, a 2-wavelength common area A2, and a 3-wavelength common area A3, as well as the lens surface R1 of the objective lens R according to the embodiment, and diffraction structures different from each other are respectively formed in the three areas. As described referring to FIG. 3(c), the anti-reflection film ra is formed such that the transmittance with respect to BD light is maximum in the 2-wavelength common area A2.

The objective lens 108 is held on a holder 121, and the holder 121 is driven in a focus direction and in a tracking direction by an objective lens actuator 122. Driving the holder 121 as described above makes it possible to drive the objective lens 108 in the focus direction and in the tracking direction.

Reflected light on a disc is converted into linearly polarized light as P-polarized light with respect to the PBS 103 by the λ/4 plate 104. According to this configuration, reflected light on the disc is transmitted through the PBS 103. The PBS 103 is disposed to incline by 45 degrees with respect to the optical axes of BD light, DVD light, and CD light. According to this configuration, when BD light, DVD light, and CD light are transmitted through the PBS 103 in a convergent state as illustrated in FIG. 4(a), astigmatism is imparted on BD light, DVD light, and CD light.

The diffraction optical element 109 is configured to diffract BD light, DVD light, and CD light. The diffraction optical element 109 is designed such that the diffraction efficiency with respect to plus first-order diffracted light of BD light is high, and the diffraction efficiencies with respect to zeroth-order diffracted light of DVD light and with respect to zeroth-order diffracted light of CD light are high. The main beam of BD light is bent in a direction toward the optical axis of DVD light by the diffraction optical element 109, and is irradiated on the irradiation position of DVD light on a light receiving surface of the photodetector 110.

Four-division sensors are respectively disposed on the photodetector 110 at positions where zeroth-order diffracted light of DVD light and zeroth-order diffracted light of CD light are irradiated. As described above, the main beam of BD light is diffracted by the diffraction optical element 109, whereby the main beam of BD light is irradiated on the four-division sensor configured to receive DVD light. Further, a four-division sensor is disposed on the photodetector 110 at a position where the two sub beams of BD light diffracted on the diffraction optical element 109 are irradiated. The sensor layout of the photodetector 110 is set such that a reproduction RF signal, a focus error signal, and a tracking error signal are generated by the output from each of the sensors.

### Advantageous Effects of Embodiments

The objective lens according to the embodiment provides the following advantageous effects.

In the 2-wavelength common area A2, the anti-reflection film R1a is designed to obtain a satisfactory transmittance with respect to BD light, and accordingly, even if an aberration variation occurs due to a temperature change, it is possible to properly maintain the light amount of a spot to be irradiated on a disc. Thus, it is possible to suppress an influence such as an aberration variation due to a temperature change.

Further, according to the embodiment, the anti-reflection film R1a is designed such that the transmittance with respect to BD light does not excessively increase in the periphery of the lens surface R1, and accordingly, it is possible to converge BD light into a light spot having a proper diameter.

The optical pickup device according to the embodiment is provided with the objective lens having the above configuration, it is possible to properly maintain the light amount of a spot of BD light to be converged on a disc, even if the temperature of the objective lens changes, and thus, it is possible to suppress deterioration of recording/reproducing characteristics due to a temperature change.

The embodiment of the present invention is described as above, but the present invention, however, is not limited to the foregoing embodiment, and various modifications other than the above are applicable to the embodiment of the present invention.

For instance, in the embodiment, the anti-reflection films R1a and R2a are respectively formed on the lens surfaces R1 and R2, but alternatively, an anti-reflection film R1a may be formed only on the lens surface R1.

Further, in the embodiment, the diffraction efficiencies with respect to BD light on the diffraction structures to be formed in the BD dedicated area A1, the 2-wavelength common area A2, and the 3-wavelength common area A3 are set as illustrated in FIG. 3(b), but the diffraction efficiencies of the diffraction structures in the respective areas are not limited to the above, and may be changed as necessary according to the design concept of a lens. For instance, as illustrated in FIG. 5(b), the diffraction structures in the respective areas maybe configured such that the diffraction efficiency of BD light in the 3-wavelength common area A3 is set to be higher than the diffraction efficiency in the 2-wavelength common area A2, and is set to be lower than the diffraction efficiency in the BD dedicated area A1.

In the 3-wavelength compatible objective lens, it may be preferable to set the diffraction efficiency as illustrated in FIG. 5(b) in an actual operation to be performed in the case where the objective lens is loaded in an optical pickup device. Specifically, setting the diffraction efficiency of BD light in the 3-wavelength common area A3 to be higher than the diffraction efficiency in the 2-wavelength common area A2, and adjusting the transmittance of the anti-reflection film R1a as described above makes it possible to secure a light amount with respect to all the 3 wavelengths in a well-balanced manner without sacrificing the light amount of CD light, taking into consideration of the transmittance of the anti-reflection film R1a.

Also in the configuration illustrated in FIG. 5(b), since the diffraction efficiency in the periphery of the lens (area where the numerical aperture is large) is higher than the diffraction efficiency in the center of the lens, as well as the configuration illustrated in FIG. 3(b), it is possible to make the intensity of BD light in the periphery close to the intensity of BD light in the center, and to converge BD light into a light spot having a small diameter. Further, since the diffraction structure compatible with laser light of two wavelengths is formed in the 2-wavelength common area A2, the 2-wavelength common area A2 is likely to be affected by a temperature change, as well as the embodiment, and in view of the above, as illustrated in FIG. 5(c), it is possible to suppress shortage in the light amount of BD light due to a temperature change, as well as the foregoing embodiment, by setting the peak of the transmittance of the anti-reflection film R1a to coincide with the position of the 2-wavelength common area A2.

Further, in the embodiment, the diffraction structure P1 is formed in the BD dedicated area A1, but a diffraction structure may not be formed in the BD dedicated area A1. In the modification, CD light and DVD light entered to the BD dedicated area A1 are refracted at a position different from the focus position Pc of CD light and the focus position Pd of DVD light by the effect of the lens having an aspherical shape. It is desirable to form the diffraction structure P1 in the BD dedicated area A1, as described in the embodiment, in order to suppress aberration with respect to each laser light.

Further, in the embodiment, the anti-reflection film R1a is designed such that the transmittance with respect to BD light is gradually lowered in the BD dedicated area A1 in order to prevent decrease of a spot diameter of BD light due to a super resolution phenomenon, but in the case where it is intended to increase the transmitted light amount of BD light, the anti-reflection film R1a may be designed so as not to excessively lower the transmittance with respect to BD light in this area.

Further, in the embodiment, the anti-reflection film R1a is designed such that the transmittance with respect to BD light is maximum when the numerical aperture is substantially equal to 0.5, but as far as the numerical aperture lies in the numerical aperture range of the 2-wavelength common area A2, the anti-reflection film R1a may be designed such that the transmittance with respect to BD light is maximum when the numerical aperture is other than the above.

Further, in the embodiment, the diffraction structures P1 to P3 have a blaze configuration, but may have a step configuration.

Furthermore, in the embodiment, the objective lens R is a lens made of resin, but may be a lens made of glass.

The embodiment of the invention may be modified in various ways as necessary in the technical range of the invention as defined by the appended claims.

### DESCRIPTION OF REFERENCES

R . . . objective lens

R1 . . . lens surface

R1a . . . anti-reflection film

A1 . . . BD dedicated area (first area)

A2 . . . 2-wavelength common area (second area)

A3 . . . 3-wavelength common area (third area)

P1 . . . diffraction structure

P2 . . . diffraction structure

P3 . . . diffraction structure

R2 . . . lens surface (lens portion)

109 . . . optical lens

109a . . . lens surface (lens portion)

109b . . . lens surface (lens portion)

ra . . . anti -reflection film

What is claimed is:

1. An objective lens configured to receive first laser light in a first wavelength band, second laser light in a second wavelength band on a longer wavelength side than the first wavelength band, and third laser light in a third wavelength band on a longer wavelength side than the second wavelength band, comprising:
a lens portion configured to converge the first laser light, the second laser light, and the third laser light respectively into a light spot with a first numerical aperture, a second numerical aperture smaller than the first numerical aperture, and a third numerical aperture smaller than the second numerical aperture; and
an anti-reflection film formed on an incident surface of the lens portion, wherein
the lens portion includes, on the incident surface, a first area obtained by excluding an area corresponding to an effective diameter of the second laser light from an area corresponding to an effective diameter of the first laser light, a second area obtained by excluding an area corresponding to an effective diameter of the third laser light from the area corresponding to the effective diameter of the second laser light, and a third area corresponding to the effective diameter of the third laser light,
diffraction structures different from each other are respectively formed in the second area and in the third area, and
the anti-reflection film is designed such that a transmittance with respect to the first laser light is maximum within the second area.

2. The objective lens according to claim 1, wherein
a position of the anti-reflection film at which the transmittance with respect to the first laser light is maximum is close to a radially outer side of the second area than a center of the second area.

3. The objective lens according to claim 1, wherein
a diffraction structure different from the diffraction structures formed in the second area and in the third area is further formed in the first area of the lens portion.

4. The objective lens according to claim 3, wherein
the anti-reflection film is designed such that the transmittance with respect to the first laser light decreases, as an incident position of the first laser light is away from an optical axis on the incident surface within the first area.

5. The objective lens according to claim 1, wherein
the first laser light is laser light for a Blu-ray disc,
the second laser light is laser light for a digital versatile disc, and
the third laser light is laser light for a compact disc.

6. An optical pickup device, comprising:
a light source configured to output first laser light in a first wavelength band, second laser light in a second wavelength band on a longer wavelength side than the first wavelength band, and third laser light in a third wavelength band on a longer wavelength side than the the second wavelength band; and
an objective lens configured to receive the first laser light, the second laser light, and the third laser light, the objective lens including:
a lens portion configured to converge the first laser light, the second laser light, and the third laser light respectively into a light spot with a first numerical aperture, a second numerical aperture smaller than the first numerical aperture, and a third numerical aperture smaller than the second numerical aperture; and
an anti-reflection film formed on an incident surface of the lens portion, wherein
the lens portion includes, on the incident surface, a first area obtained by excluding an area corresponding to an effective diameter of the second laser light from an area corresponding to an effective diameter of the first laser light, a second area obtained by excluding an area corresponding to an effective diameter of the third laser light from the area corresponding to the effective diameter of the second laser light, and a third area corresponding to the effective diameter of the third laser light,
diffraction structures different from each other are respectively formed in the second area and in the third area, and
the anti-reflection film is designed such that a transmittance with respect to the first laser light is maximum within the second area.

7. The optical pickup device according to claim 6, wherein
a position of the anti-reflection film at which the transmittance with respect to the first laser light is maximum is close to a radially outer side of the second area than a center of the second area.

8. The optical pickup device according to claim 6, wherein
a diffraction structure different from the diffraction structures formed in the second area and in the third area is further formed in the first area of the lens portion.

9. The optical pickup device according to claim 8, wherein
the anti-reflection film is designed such that the transmittance with respect to the first laser light decreases, as an incident position of the first laser light is away from an optical axis on the incident surface within the first area.

10. The optical pickup device according to claim 6, wherein
the first laser light is laser light for a Blu-ray disc,
the second laser light is laser light for a digital versatile disc, and
the third laser light is laser light for a compact disc.
